(19) United States
(12) Patent Application Publication
(10) Pub. No.: US 2017/0313948 A1
(43) Pub. Date: Nov. 2, 2017

(54) PROCESS FOR BIODEGRADATION OF HYDROCARBONS IN OILY SLUDGE

(71) Applicants: Asghari BANO, Islamabad (PK); Asim SHAHZAD, Multan (PK); Samina Siddiqui, Peshawar (PK)

(72) Inventors: Asghari BANO, Islamabad (PK); Asim SHAHZAD, Multan (PK); Samina Siddiqui, Peshawar (PK)

(21) Appl. No.: 15/143,565

(22) Filed: Apr. 30, 2016

(51) Int. Cl. C10G 32/00; C05B 7/00; A01G 1/00; C05G 3/04; A01C 21/00

(52) U.S. Cl. CPC C10G 32/00; C05G 3/04; A01C 21/00; A01G 1/001; C05B 7/00

(57) ABSTRACT

A process of biodegradation of hydrocarbons using a plant growth promoting rhizobacteria (PGPR) consortium mixed with the oily sludge, The PGPR consortium is created by inoculating a nutrient broth with pure culture of isolated bacterial strains of Bacillus pumilus, Bacillus subtilis, Pseudomonas putida and Exiguobacterium at Optical Density 1 at 660 nm and bacterial density of 10⁶ cells/ml, and incubating the inoculated nutrient broth in a shaker incubator for forty-eight to seventy-two hours at 150 rpm.

### TECHNICAL FIELD

The present disclosure relates generally to a process of biodegradation of hydrocarbons in an oily sludge. More particularly, and without limitation, the present disclosure relates to a process of biodegradation of hydrocarbons using a plant growth promoting rhizobacteria (PGPR) consortium mixed with the oily sludge.

### BACKGROUND

Oil spills are major threat to the environment as they have serious negative impacts on ecosystems in the surrounding environments. Oil spills may occur based on negligence by various entities or as result of leakage from oil well. Beyond causing pollution, oil spills may impact quality of soil leading to increase in fire hazards, groundwater pollution due to percolation, and air pollution due to evaporation, but significantly oil pills may have a significant negative on agricultural productivity-the ability to utilize contaminated soil for agricultural harvesting can significantly alter localized economies.

In addition to accidental oil leakage the hydrocarbon oil spills also create environmental pollution—hydrocarbon. Oil refineries need a well-planned oily sludge management strategy to manage oily sludge. The plants are unable to survive on oily sludge.

A simple approach that has been conventionally utilized is to dump the oily sludge into specially constructed pits. Since the possibility of seepage cannot be ruled out, the ideal sludge pit incorporates leachate collection system and a polymer lining to prevent the percolation of contaminants into the groundwater. But the pits are very expensive; in addition they are also needed in large numbers for a single refinery. Since there is a limit to the area available within a refinery, alternative solutions for the eradication of oily sludge have to be utilized.

Exemplary embodiments, consistent with the present disclosure, therefore aim to resolve the aforementioned problems, among others.

### SUMMARY

An object of the invention is to provide a new and improved process of biodegradation of hydrocarbons in an oily sludge.

In an exemplary embodiment, a process for biodegradation of hydrocarbons in an oily sludge, comprising the steps of creating a biodegradation consortium by inoculating a nutrient broth with pure culture of isolated bacterial strains of Bacillus pumilus, Bacillus subtilis, Pseudomonas putida and Exiguobacterium at Optical Density 1 at 660 nm and bacterial density of 10⁶ cells/ml, incubating the inoculated nutrient broth in a shaker incubator for forty-eight to seventy-two hours at 150 rpm, mixing the biodegradation consortium with the oil sludge to produce treated oil sludge, wherein the oil sludge containing nC11-nC30 hydrocarbons and the mixing comprises adding 4 to 5 milliliters of the biodegradation consortium for every 50 grams of the oily sludge. The process further includes mixing the treated oil sludge with soil, adding fertilizer comprising of nutrients (NH₄NO₃) and (NH₄)₂HPO₄ to the mixture of the treated oil sludge and the soil at rates of 70 μg/g and 7 μg/g respectively to produce fertilized soil, inoculating agricultural products comprising one of maize seeds, alfalfa seeds, or Mangrove roots, wherein inoculating the maize seeds and alfalfa seeds comprises washing the respective seeds with 95% ethanol following by soaking in 10% Clorox for two to three minutes, washing the seeds successively 2-3 times in autoclaved distilled water, and soaking the seeds in the biodegradation consortium for three to four hours, and inoculating the mangrove roots comprises washing the mangrove roots with double deionized water and air drying and sowing the inoculated agricultural products in the fertilized soil.

### BRIEF DESCRIPTION OF THE DRAWINGS

The accompanying drawings, which are incorporated in and constitute a part of this specification, illustrate exemplary embodiments of the present disclosure and, together with the description, serve to explain the principles of the disclosure.

FIG. 1 shows an exemplary process 100 for biodegradation of hydrocarbons in an oily sludge, consistent with exemplary embodiments of the present disclosure.

FIG. 2 shows a graph of an exemplary total bacterial count of strains in an oily sludge, consistent with exemplary embodiments of the present disclosure.

FIG. 3 illustrates a graph of exemplary results depicting degradation of oily sludge without fertilizer, consistent with exemplary embodiments of the present disclosure.

FIG. 4 illustrates a graph of exemplary results depicting degradation of oily sludge with fertilizer, consistent with exemplary embodiments of the present disclosure.

FIG. 5 illustrates a graph of exemplary results depicting degradation of oily sludge due to use of exemplary consortium, consistent with exemplary embodiments of the present disclosure.

FIG. 6 illustrates a graph of exemplary results depicting effect of exemplary consortium in germination percentage of Maize plants, consistent with exemplary embodiments of the present disclosure.

FIG. 7 illustrates a graph of exemplary results depicting effect of exemplary consortium on protein and proline content of Maize plants, consistent with exemplary embodiments of the present disclosure.

FIG. 8 illustrates a graph of exemplary results depicting effect of exemplary consortium on Enzyme (SOD) activity of Maize plants, consistent with exemplary embodiments of the present disclosure.

FIG. 9 illustrates a graph of exemplary results depicting effect of exemplary consortium on Enzyme (POD) activity of Maize plants, consistent with exemplary embodiments of the present disclosure.

### DETAILED DESCRIPTION

Bioremediation is an efficient mechanism to remediate oil-contaminated sites. Bioremediation is a process that employs microorganisms that are able to degrade toxic contaminants for the reclamation of polluted sites. Bioremediation has the ability to treat the contaminants on-site thus ensuring that the contaminant is not merely moved from one place to another. Apart from the various factors like the type and characteristics of the soil, nutrient and oxygen availability, various sampling and analytical techniques, a successful approach towards bioremediation involves the use of indigenous microorganisms, their survival, and their response to toxic oil contaminants as well as nutrient enrichment. The reintroduction of indigenous microorganisms isolated from the contaminated sites after culturing seems to be a highly effective bioremediation approach, especially when oxygen and fertilizers supplement the growth of the microorganisms. The prepared exemplary consortium has ability to remediate the oily sludge and also have plant growth promoting abilities which can reclaim the oil contaminated soil for agricultural purpose.

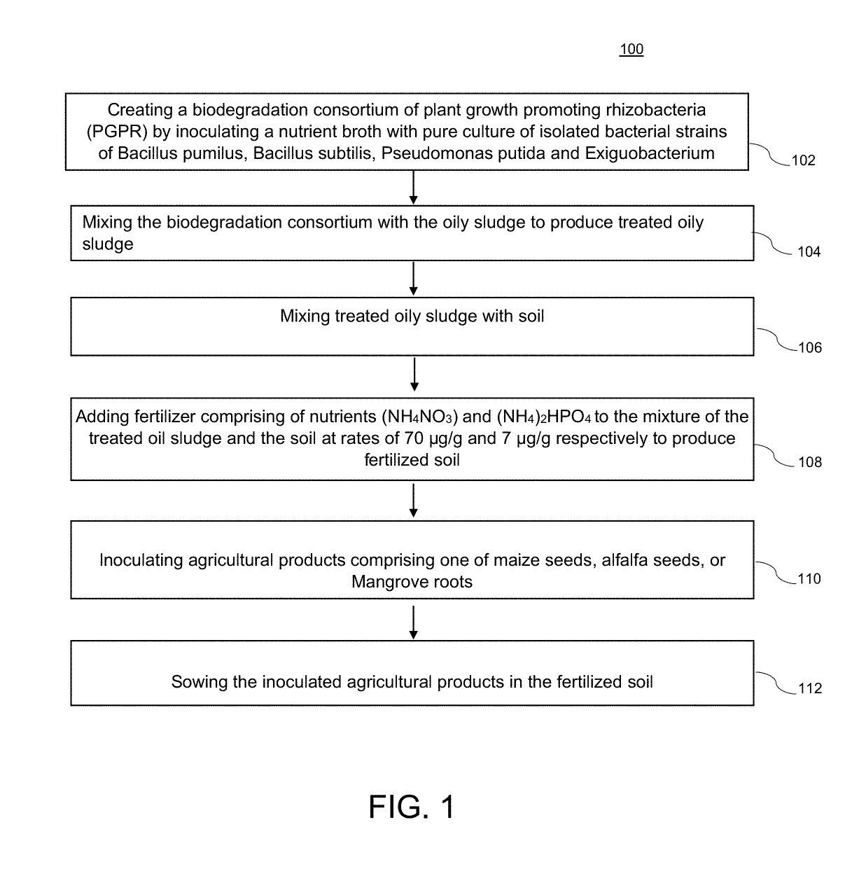

FIG. 1 shows an exemplary process 100 for biodegradation of hydrocarbons in an oily sludge, consistent with exemplary embodiments of the present disclosure. In an exemplary embodiment, the oily sludge may be extracted by utilizing soxhelt extraction. For example, the solvent n-hexane may be used for extracting saturates, a ratio of n-hexane:dichloromethane (3:7) to extract aromatics, a ration of dichloromethane:methanol (7:3) to extract polar, and methanol to extract non-polar compounds.

Step 102 may consist of creating a biodegradation consortium of plant growth promoting rhizobacteria (PGPR) by inoculating a nutrient broth with pure culture of isolated bacterial strains of Bacillus pumilus, Bacillus subtilis, Pseudomonas putida and Exiguobacterium at Optical Density 1 at 660 nm and bacterial density of 10⁶ cells/ml, incubating the inoculated nutrient broth in a shaker incubator for forty-eight to seventy-two hours at 150 rpm.

In an exemplary embodiment, the four strains that are isolated may be chosen based on their capability to degrade total petroleum hydrocarbons (TPHs). This may be done in a laboratory setting.

The isolation of the isolated strains may be conducted in an exemplary scenario by suspension of subsamples of sludge (1 g) taken in triplicate by adding 9 ml of sterile water to 1 g of sludge sample from each treatment, stirred on magnetic stirrer. The suspension may then be centrifuged at 3000 rpm for 10 minutes. Supernatant may then be removed through micropipette and the pellet containing bacterial cells is suspended in the autoclaved distilled water from which decimal dilutions may be prepared. Aliquots (80 μl) of each serial dilution (10⁻¹ to 10⁻¹¹) may then be spread over autoclaved nutrient agar plates and incubated at 32±2° C. for 24 hours. The bacterial colonies may then counted on dilution plates and calculated by utilizing the following formula: Viable cell count (CFU/g soil)=(number of colonies/volume of inoculum)×dilution factor. The nutrient broth (Nutrient Broth OXOID-UK) may then be inoculated with pure culture of isolated bacterial strains were incubated in shaker incubator for 48 to 72 hours at 150 rpm. The nutrient broth containing the pure culture of bacterial strains may be centrifuged at 3000 rpm. The residue or the cetrifugate called bacterial cells pellet may then be resuspended in autoclaved distilled water and the Optical Density may be adjusted to 1 at 660 nm using distilled water.

Step 104 may include mixing the biodegradation consortium with the oily sludge to produce treated oil sludge. The oil sludge may contain nC11-nC30 hydrocarbons, which include n-C11H24(n-undecane), nC12H26 (n-dodecane), nC13H28(n-tridecane), nC1430H(n-tetradecane), nC15H32(n-Pentadecane), nC16H34(n-hexadecane), nC17H36(n-heptadecane), nC18H38(n-hexadecane), nC19H40(n-nonadecane), nC20H42(eicosane), nC21H44 (n-Heneicosane), C22H46 (n-Docosane), C23H48 (n-Tricosane), C24H50 (n-Tetracosane), C25H52 (n-Pentacosane), C26H54 (n-Hexacosane), C27H56 (n-Heptacosane), C28H58 (n-Octacosane), C29H60 (n-Nonacosane), C30H62 (n-Triacontane), C31H64 (n-Hentriacontane), C32H66 (n-Dotriacontane), C33H68 (n-Tritriacontane), C34H70 (n-Tetratriacontane), C35H72 (n-Pentatriacontane), C36H74 (n-Hexatriacontane), nC37H76 (n-Heptatriacontane), nC38H78 (n-Octatriacontane), C39H80 (n-Nonatriacontane), C40H82 (n-Tetracontane), C41H84 (n-Hentetracontane), C42H86 (n-Dotetracontane), C43H88 (n-Tritetracontane), C44H90 (n-Tetratetracontane). In an embodiment, nitrogen and phosphorus may be the limiting nutrients in oily sludge contaminated soils. Therefore these nutrients may be used to accelerate the rate of degradation of hydrocarbons in oily sludge. Accordingly, the added nutrients may be specific to the nutrient deficiency. In an embodiment, the mixing may consist of adding 4 to 5 milliliters of the biodegradation consortium for every 50 grams of the oily sludge.

Step 106 may consist of mixing treated oily sludge with soil. The ratio of oil sludge to soil may be in a range of 3 to 7 or 6 to 4. The soil may be uncontaminated soil. The oily sludge may be extracted at a location where an oil spill has occurred.

Step 108 may consist of adding fertilizer comprising of nutrients (NH₄NO₃) and (NH₄)₂HPO₄ to the mixture of the treated oil sludge and the soil at rates of 70 μg/g and 7 μg/g respectively to produce fertilized soil. In embodiments, there are various ranges of fertilizer added to oily sludge depend on oily sludge characteristics. The fertilizer may be added in a one to one ratio of the consortium.

Step 110 may consist of inoculating agricultural products comprising one of maize seeds, alfalfa seeds, or Mangrove roots. In an exemplary embodiment, inoculating the maize seeds and alfalfa seeds comprises washing the respective seeds with 95% ethanol following by soaking in 10% Clorox for two to three minutes, washing the seeds s successively 2-3 times in autoclaved distilled water, and soaking the seeds in the biodegradation consortium for three to four hours. In another exemplary embodiment, inoculating the mangrove roots comprises washing the mangrove roots with double deionized water and air drying. The mangrove roots may further be grinded in powder form and then added to the oily sludge contaminated soil at the rate of one gram per two-hundred grams of oily sludge. In another exemplary embodiment, additional agricultural products may be used. Additionally, agricultural products may be inoculated utilized the methods described above or other methods of cleaning and treatment.

Step 112 may consist of sowing the inoculated agricultural products in the fertilized soil. Accordingly, the agricultural products inoculated using step 110 may be sown in the fertilized soil. As illustrated in the various examples cited below, exemplary process 100 allows for bioremediation of hydrocarbons and for growth of agricultural products.

Exemplary process may be utilized for effective and efficient biodegradation of hydrocarbons. The process functions in normal weather, negating the need for extra resources to be utilized such as resources needed to apply heat, etc.

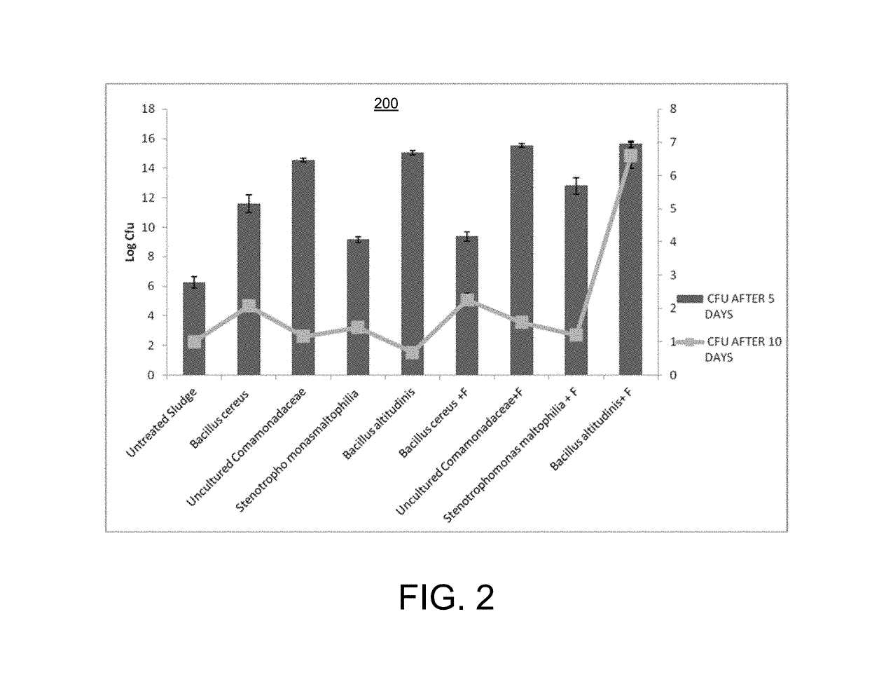

FIG. 2 shows a graph 200 of an exemplary total bacterial count of strains in an oily sludge, consistent with exemplary embodiments of the present disclosure. Measurements were made for determination of the survival of the PGPR isolated in the oily sludge. Colony forming unit (CFU) 204 was taken as measure of their survival potential. FIG. 2 illustrates an exemplary variation of bacterial counts during biodegradation of oily sludge inoculated with various individual strains, which were combined to form the exemplary PGPR consortium. The bacterial count was increased in all the treatments two-folds as compared to untreated sludge at five days. With the addition of fertilizer, the bacterial count was increased further by two-folds in all the treatments than untreated sludge. At ten days of incubation, the bacterial count was decreased when compared with the bacterial count at five days. With addition of fertilizer the bacterial count in sludge inoculated with Bacillus altitudinis increased nine-folds at ten days. Whereas, the fertilizer addition has no significant effect in other strains and the bacterial count remained steady with all other strains at ten days of incubation. CFU at five days is reflected on the left side of the graph on the y-axis, while CFU at ten days on the right side.

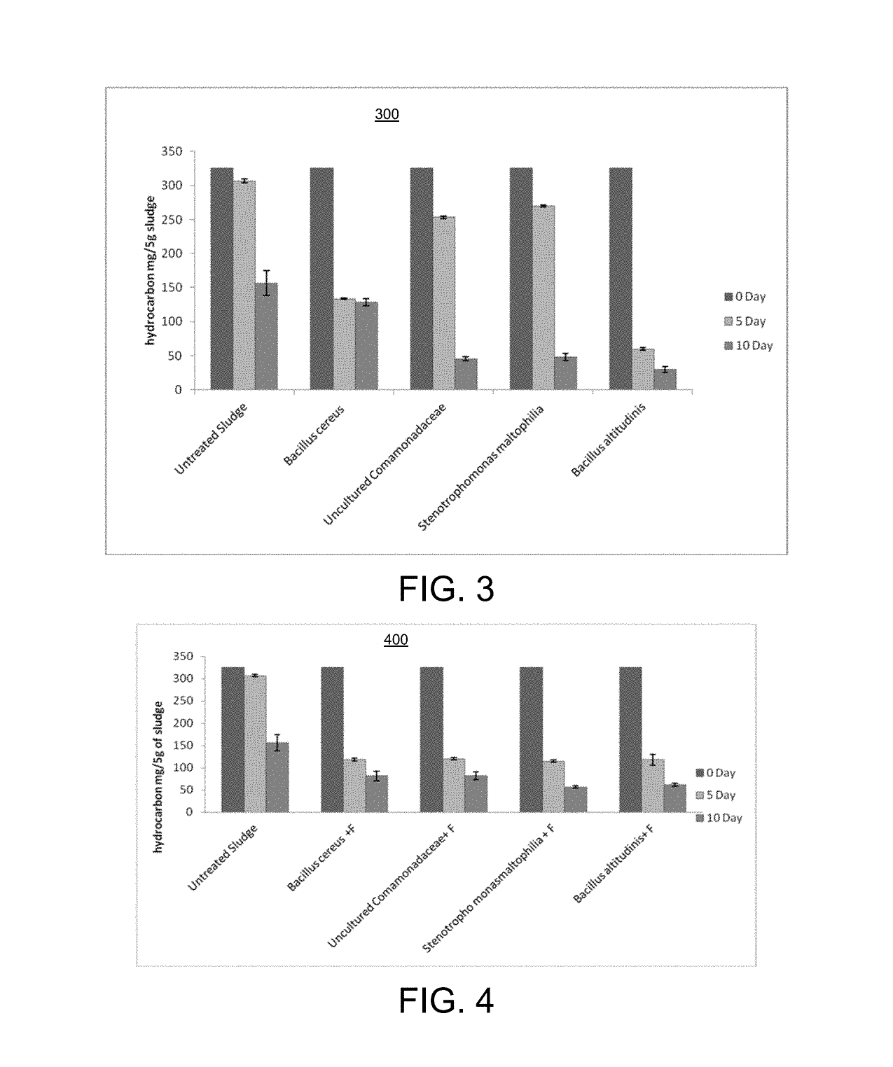

FIG. 3 illustrates a graph 300 of exemplary results depicting degradation of oily sludge without fertilizer, consistent with exemplary embodiments of the present disclosure. As illustrated, hydrocarbons were degraded by the addition of Bacillus cereus, Comamonas, Stenotrophomonas maltophilia and Bacillus altitudinis alone. The Bacillus altitudinis degraded 80% of hydrocarbon at five days and increased from 80% to 91% from the period between give days and ten days of incubation. Inoculation of Comamonas and Stenotrophomonas maltophilia resulted in the degradation of hydrocarbon from 22% to 86% and 16% to 85% respectively during the period from five days to ten days of incubation.)

FIG. 4 illustrates a graph 400 of exemplary results depicting degradation of oily sludge with fertilizer, consistent with exemplary embodiments of the present disclosure. All exemplary PGPR showed almost a similar percentage of degradation between 63 to 64 percent at 5 days of incubation when the isolated strands and fertilizer was utilized. Due to the utilization of the fertilizer, percentage of degradation of hydrocarbons increased from 58 to 63 percent, 22 to 63 percent, and 17 to 64 percent when Bacillus cereus, Comamonas and Stenotrophomonas maltophilia were utilized respectively. However, the degradation decreased when Bacillus altitudinis was utilized. The exemplary increase or decrease was recorded as compared to the untreated sludge. At ten days of incubation, all the strains showed significant difference in the percentage of degradation of hydrocarbons in the oily sludge. The percentage degradation increased from 63 to 75 percent, 63 to 75 percent, 64 to 82 percent, and 63-81 percent in oily sludge treated with Bacillus cereus, Comamonas and Stenotrophomonas maltophilia and Bacillus altitudinis respectively from the time period between five days and tend days of incubation.

In an exemplary embodiment, the degradation of the oily sludge may occur utilizing exemplary isolated strains or exemplary consortium. The degradation of hydrocarbons may start occurring at normal or room temperature. The degradation may be further aided by the addition of fertilizer, as described in relation to process 100.

TABLE 1

| | Days from Incubation | | | | |
|---|---|---|---|---|---|
| TREATMENT | 3 | 7 | 14 | 21 | 28 |
| T1 = Untreated Sludge | 1.62 × 10⁻¹ | 3.06 × 10⁻³ | 2.2 × 10⁻¹ | 2.75 × 10⁻¹ | 3.45 × 10⁻¹ |
| T2 = Consortium added to | 4.77 × 10⁻¹ | 0 | 2.38 × 10⁻¹ | 2 × 10⁻¹ | 6.08 × 10⁻¹ |
| sludge | | | | | |
| T3 = Consortium and fertilizer | 7.61 × 10⁻¹ | 5.52 × 10⁻³ | 7.9 × 10⁻¹ | 15.62 × 10⁻¹ | 7.1 × 10⁻¹ |
| added to sludge | | | | | |
| T4 = Consortium and fertilizer | 4.17 × 10⁻¹ | 0.45 × 10⁻³ | 13.01 × 10⁻¹ | 6.13 × 10⁻¹ | 5.16 × 10⁻¹ |
| added to sludge with Alfalfa | | | | | |
| plants | | | | | |
| T5 = Maize grown in sludge | 3.12 × 10⁻³ | 5.8 × 10⁻⁵ | 5.47 × 10⁻⁷ | 2.88 × 10⁻⁹ | 4.2 × 10⁻¹¹ |
| T6 = Consortium added to | 5.83 × 10⁻³ | 7.6 × 10⁻⁵ | 8.16 × 10⁻⁷ | 10.4 × 10⁻⁹ | 3.27 × 10⁻¹¹ |
| sludge, with maize grown in it | | | | | |
| T7 = Fertilizer added to sludge | 7.11 × 10⁻³ | 18.6 × 10⁻⁵ | 12.25 × 10⁻⁷ | 9.88 × 10⁻⁹ | 4.9 × 10⁻¹¹ |
| with maize grown in it | | | | | |
| T8 = Consortium and fertilizer | 3.93 × 10⁻³ | 4.5 × 10⁻⁵ | 4.6 × 10⁻⁷ | 1.5 × 10⁻⁹ | 5.75 × 10⁻¹¹ |
| added to sludge, with maize | | | | | |
| grown in | | | | | |

Table 1 presented above presents the effects of use of various combinations of fertilizer, consortium, and/or plants on bacterial population measured as Colony Forming Unit (CFU) in an exemplary oily sludge at different time intervals, the time intervals being in terms of days after incubation in the oily sludge.

Table 1 shows variation in bacterial counts during the biodegradation of untreated oily sludge (T1). Bacterial counts initially decreased from 1.62×10⁻¹ to 3.0×10⁻³ CFU/g sludge within seven days which again increased at fourteen days and remain steady until twenty-eight days. With the addition of consortium (T2), bacterial count increased almost three-folds after three days but no count was detected at seven days and increased again having CFU at a similar level as untreated sludge until twenty-one days and increased two-folds greater than untreated sludge at twenty-eight days. Whereas, with the addition of consortium and fertilizer (T3) bacterial count was increased seven-folds at day three and decreased at seven days. Thereafter, bacterial count increased four-folds than untreated sludge and this increase was up to seven-folds at twenty-one days.

Further with planting of Alfalfa (T4), the bacterial count was increased by three-folds greater than untreated sludge at three days which decreased at seven days. Thereafter, it showed almost six-folds greater bacterial count than untreated sludge at fourteen days. Then, the bacterial count decreased three-folds and remained steady during twenty-one and twenty-eight days.

Planting of maize seeds coated with consortium decreased the bacterial count at three days as compared to untreated sludge and showed linear decrease until twenty-eight days (T5). With the addition of fertilizer and planting of maize (T6) bacterial count was decreased than untreated sludge and remained low until twenty-eight days. With the addition of fertilizer and planting of maize (T7), the bacterial count was decreased at three days and continued until twenty-eight days. Combined treatment with consortium and fertilizer, with maize planted in it (T8) resulted in a decrease of count as compared to untreated sludge and showed linear decrease until twenty-eight days.

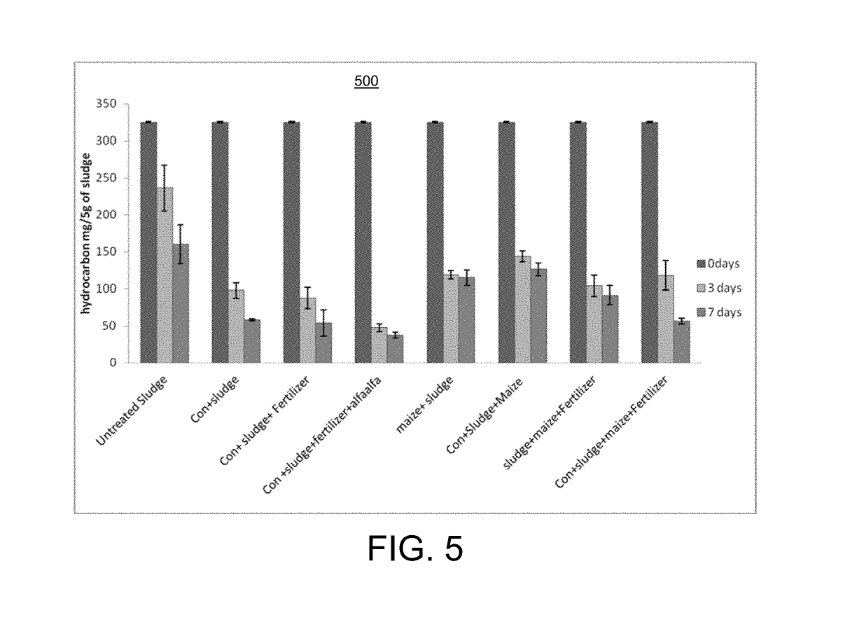

FIG. 5 illustrates a graph 500 of exemplary results depicting degradation of oily sludge due to use of exemplary consortium, consistent with exemplary embodiments of the present disclosure. In an exemplary embodiment, addition of consortium leads to seventy percent of degradation of hydrocarbons at three days of incubation. From the period between days three to seven, the degradation increased from seventy to eighty-two percent. In instances, where the consortium and the fertilizer was utilized, the hydrocarbons were degraded by sat three days of incubation. While, in the period between days three to seven, the degradation increased from seventy-three to eighty-three percent. In one exemplary scenario, combined application of exemplary consortium, fertilizer, and alfalfa seed degraded hydrocarbons at eighty-five percent at three days of incubation. While, in the period between days three and seven, the degradation increased from eighty-five to eighty-eight percent. In another exemplary scenario, combined application of exemplary consortium, fertilizer, and maize degraded hydrocarbons at sixty-four percent at three days of incubation. While, in the period between days three and seven, the degradation increased from sixty-four to eighty-two percent.

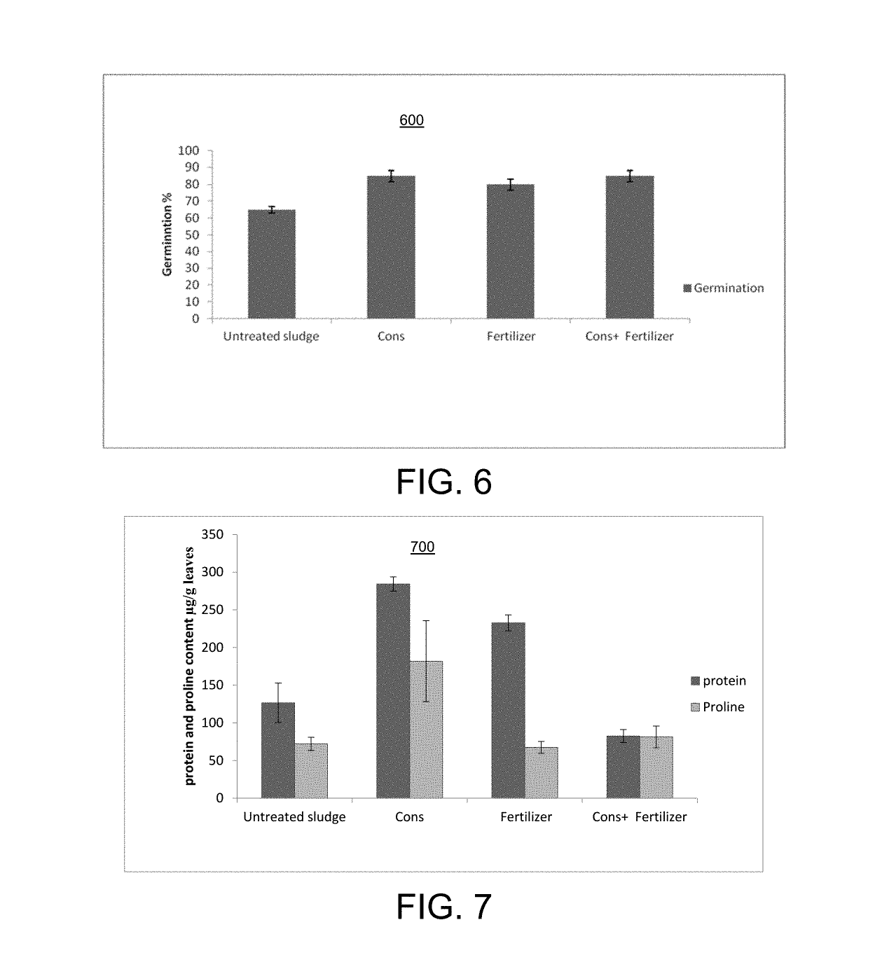

FIG. 6 illustrates a graph 600 of exemplary results depicting effect of exemplary consortium in germination percentage of Maize plants, consistent with exemplary embodiments of the present disclosure. As illustrated, the germination percentage of maize plants in untreated oily sludge was lower as compared to treated sludge that was treated utilizing exemplary steps of process 100. The addition of the exemplary consortium to produce treated sludge, led to a twenty percent increase in germination percentage compared to untreated sludge. Fertilizer addition in combination with the exemplary allowed the germination percentage to remain at twenty percent. The addition of only fertilizer by itself led to a percent germination equal to fifteen percent.

In an exemplary embodiment, Alfalfa plants inoculated utilizing exemplary steps of process 100 with exemplary consortium were able to survive up to fourteen days of germination in an untreated oily sludge while uninoclutaed plants were unable to survive more than seven day. On the other hand, maize plants showed an even better ability to survive, lasting for up to twenty-five days when inoculated with exemplary continuum.

FIG. 7 illustrates a graph 700 of exemplary results depicting effect of exemplary consortium on protein and proline content of Maize plants, consistent with exemplary embodiments of the present disclosure. Graph 700 illustrates that due to addition of exemplary consortium to sludge, the protein content of leaves of maize grown in sludge was increased to a level that was fifty-give percent higher than the protein content of maize grown in untreated sludge. With the addition of fertilizer the protein content increased forty-six percent as compared to the protein of maize grown in untreated sludge. However, when exemplary consortium and fertilizer were both added to oily sludge, the protein content of maize grown decreased the protein by thirty-four percent as compared to untreated sludge.

As illustrated in graph 700, the addition of exemplary consortium increased the proline content of maize plants by a hundred and nine percent 109 than maize plants grown in untreated sludge. The addition of just fertilizer led to a six percent decrease in proline content of the maize plants. However, the combined application of exemplary consortium and fertilizer led to an increase of proline content by eleven percent in the maize plants compared to maize plants grown in untreated sludge.

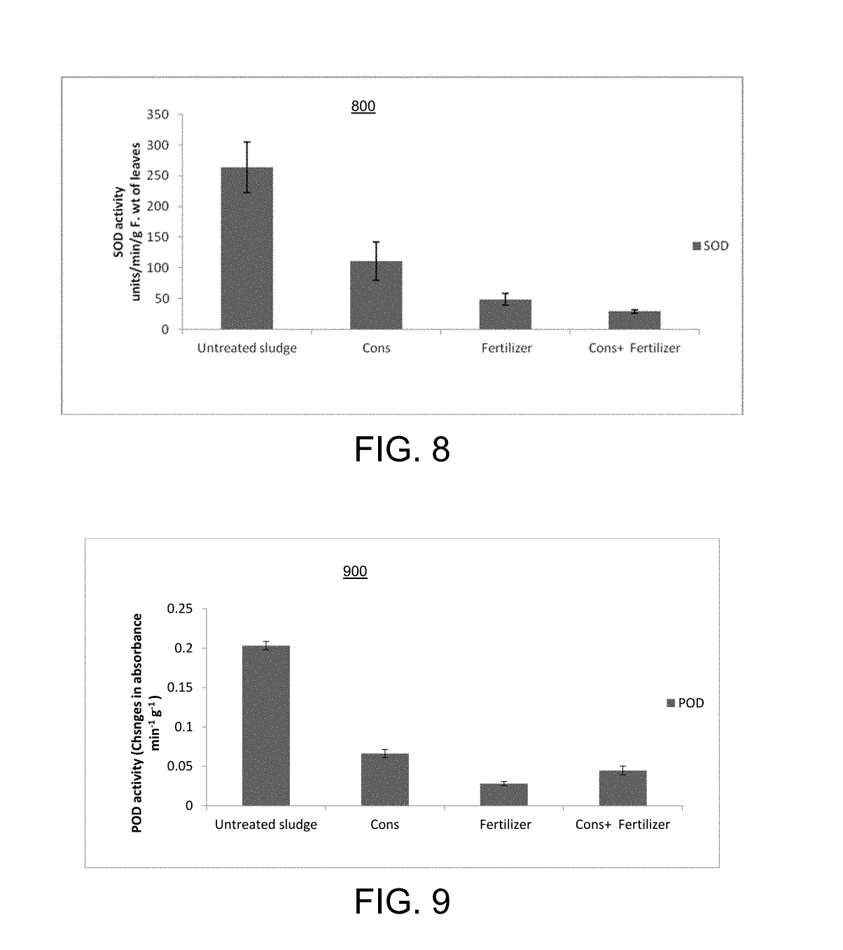

FIG. 8 illustrates a graph 800 of exemplary results depicting effect of exemplary consortium on Enzyme (SOD) activity of Maize plants, consistent with exemplary embodiments of the present disclosure. With the addition of the exemplary consortium, SOD activity was decreased fifty-eight percent as compared to untreated sludge. Addition of fertilizer lead to decrease of the SOD activity to eight-one percent. However, the combined utilization of exemplary consortium and the fertilizer resulted eighty-nine percent decrease in SOD activity compared to SOD of untreated sludge.

FIG. 9 illustrates a graph 900 of exemplary results depicting effect of exemplary consortium on Enzyme (POD) activity of Maize plants, consistent with exemplary embodiments of the present disclosure. With the addition of the exemplary consortium, POD activity was decreased sixty-seven percent as compared to untreated sludge. Addition of fertilizer lead to decrease of the POD activity to eight-six percent. However, the combined utilization of exemplary consortium and the fertilizer resulted seventy-eight percent decrease in POD activity compared to POD of untreated sludge.

What is claimed:

1. A process for biodegradation of hydrocarbons in an oily sludge, comprising the steps of:
creating a biodegradation consortium by inoculating a nutrient broth with pure culture of isolated bacterial strains of Bacillus pumilus, Bacillus subtilis, Pseudomonas putida and Exiguobacterium at Optical Density 1 at 660 nm and bacterial density of 10⁶ cells/ml, and incubating the inoculated nutrient broth in a shaker incubator for forty-eight to seventy-two hours at 150 rpm;
mixing the biodegradation consortium with the oily sludge to produce treated oil sludge, wherein:
the oily sludge contains nC11-nC30 hydrocarbons; and
the mixing the biodegradation consortium with the oily sludge comprises adding 4 to 5 milliliters of the biodegradation consortium for every 50 grams of the oily sludge;
mixing the treated oil sludge with soil;
adding fertilizer comprising of nutrients (NH₄NO₃) and (NH₄)₂HPO₄ to the mixture of the treated oily sludge and the soil at rates of 70 μg/g and 7 μg/g respectively to produce fertilized soil;
inoculating agricultural products comprising one of maize seeds, alfalfa seeds, or Mangrove roots, wherein:
inoculating the maize seeds and alfalfa seeds comprises washing the respective seeds with 95% ethanol following by soaking in 10% Clorox for two to three minutes, washing the seeds successively 2-3 times in autoclaved distilled water, and soaking the seeds in the biodegradation consortium for three to four hours, and
inoculating the mangrove roots comprises washing the mangrove roots with double deionized water and air drying; and
sowing the inoculated agricultural products in the fertilized soil.

2. The process of claim 1, wherein inoculating the mangrove roots further comprises cutting the mangrove roots in small pieces and chopping them into powder form.

3. The process of claim 1, wherein mixing the treated oil sludge to the soil comprises mixing the treated oil sludge to the soil is in a range of ratios from 3:7 to 6:4 respectively.

4. A process for biodegradation of hydrocarbons in an oily sludge, comprising the steps of:
creating a biodegradation consortium by inoculating a nutrient broth with pure culture of isolated bacterial strains of Bacillus pumilus, Bacillus subtilis, Pseudomonas putida and Exiguobacterium;
mixing the biodegradation consortium with the oily sludge to produce treated oil sludge by adding 4 to 5 milliliters of the biodegradation consortium for every 50 grams of the oily sludge;
mixing the treated oily sludge with soil;
adding fertilizer to the mixture of the treated oily sludge and the soil to produce fertilized soil;
inoculating agricultural products; and
sowing the agricultural products in the fertilized soil.

5. The process of claim 4, wherein:
the agricultural products comprise of one of maize seeds and alfalfa seeds; and
inoculating the maize seeds and the alfalfa seeds comprises washing the respective seeds with 95% ethanol following by soaking in 10% Clorox for two to three minutes, washing the seeds successively 2-3 times in autoclaved distilled water, and soaking the seeds in the biodegradation consortium for three to four hours.

6. The process of claim 4, wherein:
the agricultural products comprise of mangrove roots; and
inoculating the mangrove roots comprises washing the mangrove roots with double deionized water and air drying.

7. The process of claim 6, wherein inoculating the mangrove roots further comprises cutting the mangrove roots in small pieces and crushing them into powder form.

8. The process of claim 4, wherein mixing the treated oily sludge to the soil comprises mixing the treated oily sludge to the soil is in a range of ratios from 3:7 to 6:4 respectively.

9. The process of claim 4, wherein creating the biodegradation consortium by inoculating a nutrient broth with pure culture of isolated bacterial strains of Bacillus pumilus, Bacillus subtilis, Pseudomonas putida and Exiguobacterium comprises creating the biodegradation consortium by inoculating the nutrient broth with pure culture of isolated bacterial strains of Bacillus pumilus, Bacillus subtilis, Pseudomonas putida and Exiguobacterium at Optical Density 1 at 660 nm and bacterial density of 10⁶ cells/ml, incubating the inoculated nutrient broth in a shaker incubator for forty-eight to seventy-two hours at 150 rpm;

10. The process of claim 4, wherein adding fertilizer to the mixture of the treated oil sludge and the soil to produce fertilized soil comprises adding of nutrients (NH₄NO₃) and (NH₄)₂HPO₄ to the mixture of the treated oily sludge and the soil at rates of 70 μg/g and 7 μg/g respectively to produce fertilized soil.
